(19) United States
(12) Patent Application Publication
(10) Pub. No.: US 2022/0108620 A1
(43) Pub. Date: Apr. 7, 2022

(54) SYSTEMS AND METHODS FOR VISUALIZING AN ASSUMED LATERAL AND VERTICAL FLIGHT PATH ON AN AVIONIC DISPLAY

(71) Applicant: HONEYWELL INTERNATIONAL INC., Charlotte, NC (US)

(72) Inventors: Tomas Bouda, Brno (CZ); Petra Machackova, Vsetin Rybniky (CZ); Stepan Dopita, Brno (CZ); Ivan Lacko, Brno (CZ)

(73) Assignee: HONEYWELL INTERNATIONAL INC., Charlotte, NC (US)

(21) Appl. No.: 17/061,060

(22) Filed: Oct. 1, 2020

(51) Int. Cl. G08G 5/00

(52) U.S. Cl. CPC G08G 5/0021; G08G 5/0047; G08G 5/0034; G08G 5/0013

(57) ABSTRACT

A flight display system for providing a visualization of an assumed lateral and vertical flight path on an avionic display for an aircraft performing energy management during an approach procedure, and methods for producing the same. The system improves upon available human-machine interfaces (HMI) by providing information not otherwise available; that being, a visualization of an assumed lateral and vertical flight path to assist the flight crew in making adjustments to the configuration of the aircraft when the aircraft is making an approach to an airport.

### TECHNICAL FIELD

The present disclosure relates generally to information presented by flight display systems on an aircraft during approach procedures. More particularly, embodiments of the present disclosure provide a visualization of an assumed lateral and vertical flight path on an avionic display for an aircraft performing energy management during an approach procedure, such as an approach to landing at an airport.

### BACKGROUND

Energy management of the aircraft during the approach is a topic of great concern in the aviation industry. As used herein, the term “energy management” relates, at least in part, to the kinetic energy of the aircraft (forward motion through space) and the potential energy of the aircraft (in reference to its height above aerodrome elevation). Proper execution of energy management can significantly reduce landing related incidents and thus improve overall safety statistics for the aviation industry.

However, energy management presents a complex technical problem, in part because it requires an algorithm that considers multiple parameters, e.g. speed, altitude, configuration, distance from the threshold, lateral and vertical route constraints, etc. Another aspect of this technical problem includes properly communicating the output of such an algorithm to end users, i.e., the flight crew/pilot. Various algorithms and commercial implementations have been published in the art, which can provide various styles of “outputs” for energy management support. Nonetheless, continued improvements to the presentation of information during an energy managed approach are desirable.

Accordingly, the present disclosure provides a technical solution in the form of flight display systems and methods that provide an improved human-machine interface (HMI) on an avionic display for an aircraft performing energy management during an approach procedure. Embodiments of the improved HMI provide a visualization of an assumed lateral and vertical flight path during performance of an approach procedure. Other desirable features and characteristics of the present invention will become apparent from the subsequent detailed description of the invention and the appended claims, taken in conjunction with the accompanying drawings and this background of the invention.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Provided is a flight display system for providing a visualization of an assumed lateral and vertical flight path on an avionic display for an aircraft performing energy management during an approach procedure, comprising: a flight management system (FMS); a source of aircraft status data; a display device capable of rendering a navigation display and a vertical situation display (VSD); and a controller circuit coupled to the FMS, the source of aircraft status data, and the display device, the controller circuit programmed by programming instructions to receive and process aircraft status data and aircraft configuration data, determine a current energy situation of the aircraft, and to command the display device to render the navigation display and the VSD, the controller circuit further programmed to: determine an optimum energy position on the descent, defined as a position for employing an optimum configuration for energy on the descent, as a function of the current energy situation; determine a critical energy position on the descent, defined as a position for changing an aircraft configuration to a final configuration, wherein the final configuration represents a maximum drag configuration of the aircraft that is greater than the optimum configuration and involves the extension of each of: flaps, airbrakes, and landing gear, the critical energy position represents a position after which, regardless of aircraft configuration, the aircraft can no longer arrive at the final approach gate in the energy-stabilized manner; determine when the aircraft is not on an FMS lateral path; calculate an assumed lateral path when the aircraft is not on the FMS lateral path; generate a first graphical user interface (GUI) object representing the assumed lateral path when the aircraft is not on the FMS lateral path; render the first GUI object on the navigation display; determine when the aircraft is not on an FMS vertical path; calculate an assumed vertical path when the aircraft is not on the FMS vertical path; generate a second graphical user interface (GUI) object representing the assumed vertical path when the aircraft is not on the FMS vertical path; render the second GUI on the VSD; select a presentation style from among a plurality of presentation styles for rendering an optimum energy indicator and a critical energy indicator; render the optimum energy indicator, as an overlay, on each of the first GUI object and the second GUI object; and render the critical energy indicator, as an overlay, on each of the first GUI object and the second GUI object.

Also provided is a method for providing a visualization of an assumed lateral and vertical flight path on an avionic display for an aircraft performing energy management during an approach procedure, comprising: at a controller circuit programmed by programming instructions, receiving and processing aircraft status data and aircraft configuration data, determining a current energy situation of the aircraft, and commanding a display device to render a navigation display and a VSD; determining an optimum energy position on the descent, defined as a position, from which the aircraft will decelerate to a speed for an optimum configuration change; determining a critical energy position on the descent, defined as a position, from which the aircraft will decelerate to a speed for a change to a critical configuration, wherein the critical configuration represents a maximum drag configuration of the aircraft that is greater than the optimum configuration and involves the extension of each of: flaps, airbrakes, and landing gear, the critical energy position represents a position after which, regardless of aircraft configuration, the aircraft can no longer arrive at the final approach gate in the energy-stabilized manner; determining when the aircraft is not on an FMS lateral path; calculating an assumed lateral path when the aircraft is not on the FMS lateral path; generating a first graphical user interface (GUI) object representing the assumed lateral path when the aircraft is not on the FMS lateral path; rendering the first GUI object on the navigation display; determining when the aircraft is not on an FMS vertical path; calculating an assumed vertical path when the aircraft is not on the FMS vertical path; generating a second graphical user interface (GUI) object representing the assumed vertical path when the aircraft is not on the FMS vertical path; rendering the second GUI on the VSD; selecting a presentation style from among a plurality of presentation styles for rendering an optimum energy indicator and a critical energy indicator; rendering the optimum energy indicator, as an overlay, on each of the first GUI object and the second GUI object; and rendering the critical energy indicator, as an overlay, on each of the first GUI object and the second GUI object.

Another embodiment provides a flight display system for providing a visualization of an assumed lateral and vertical flight path on an avionic display for an aircraft performing energy management during an approach procedure, the flight display system comprising a computer processor programed to determine a current energy situation of the aircraft, determine an optimum energy position, defined as a position for employing an optimum configuration for energy on a descent, determine a critical energy position on the descent, defined as a position for changing an aircraft configuration to a final configuration that represents a maximum drag configuration of the aircraft that is greater than the optimum configuration and involves the extension of each of: flaps, airbrakes, and landing gear, calculate an assumed lateral path when the aircraft is not on the FMS lateral path, and calculate an assumed vertical path when the aircraft is not on the FMS vertical path, the flight display system comprising: a display device capable of rendering a navigation display and a vertical situation display (VSD); and a controller circuit coupled to the display device, the controller circuit programmed by programming instructions to command the display device to render the navigation display and the VSD; generate a first graphical user interface (GUI) object representing the assumed lateral path when the aircraft is not on the FMS lateral path; render the first GUI object on the navigation display; generate a second graphical user interface (GUI) object representing the assumed vertical path when the aircraft is not on the FMS vertical path; render the second GUI on the VSD; select a presentation style from among a plurality of presentation styles for rendering an optimum energy indicator and a critical energy indicator; render the optimum energy indicator, as an overlay, on each of the first GUI object and the second GUI object; and render the critical energy indicator, as an overlay, on each of the first GUI object and the second GUI object.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

At least one example of the present invention will hereinafter be described in conjunction with the following figures, wherein like numerals denote like elements, and wherein:

FIG. 1 is a block diagram of a system for a flight display system for providing a visualization of an assumed lateral and vertical flight path on an avionic display for an aircraft performing energy management during an approach procedure, in accordance with an exemplary embodiment of the present disclosure;

FIG. 2 is a simplified illustration introducing features of a visualization of an assumed lateral and vertical flight path on an avionic display for an aircraft performing energy management during an approach procedure, in accordance with an exemplary embodiment of the present disclosure;

FIGS. 3-6 are more detailed illustrations showing varying aircraft locations for an aircraft performing energy management during an approach procedure, and the improved HMI provided by exemplary embodiments of the present disclosure; and

FIG. 7 is an exemplary flow diagram illustrating a method for generating an avionic display in accordance with the present disclosure.

### DETAILED DESCRIPTION

The following Detailed Description is merely exemplary in nature and is not intended to limit the invention or the application and uses of the invention. The term “exemplary,” as appearing throughout this document, is synonymous with the term “example” and is utilized repeatedly below to emphasize that the description appearing in the following section merely provides multiple non-limiting examples of the invention and should not be construed to restrict the scope of the invention, as set-out in the Claims, in any respect. As further appearing herein, the term “pilot” encompasses all users of the below-described aircraft system.

As used herein, the term “display” refers broadly to any means or method for the distribution of information to a flight crew or other aircraft operator, whether visually, aurally, tactilely, or otherwise. Also, the term “final gate” means the final position where aircraft should be stabilized to continue the approach. In current aviation regulation, a stabilization gate of 1000 feet (ft.) above airport elevation is generally preferred during Instrument Meteorological Conditions (IMC) and 500 ft. above airport elevation during Visual Meteorological Condition (VMC). Also, as used herein, the final gate “which is considered by AStA” is selectable by the aircraft operator or OEM. In various embodiments, the final gate is selectable from among 1000 feet above the aerodrome elevation, 500 feet above the aerodrome elevation, a Final Approach Fix (FAF). In other embodiments, the final gate can include any other predefined height above the aerodrome elevation to stay on a safe site.

As mentioned, energy management presents a complex technical problem, in part because it is affected by multiple parameters, e.g. speed, altitude, configuration, distance from the threshold, lateral and vertical route constraints, etc. Another aspect of this technical problem includes properly communicating the output of such an algorithm to end user, i.e., the flight crew/pilot. Various algorithms and commercial implementations have been published in the art, which can provide various solutions for energy management, including various styles of “output” or feedback for a pilot to view. One example is commonly assigned U.S. patent application publication no. 2017/0168658 A1, the contents of which are incorporated by reference herein in their entirety.

In available solutions, when the aircraft does not follow the lateral or vertical (or neither the lateral nor vertical) flight plan from FMS (regardless of the reason), a provided algorithm embodied in a software or hardware program will determine and assume the most probable lateral/vertical path. This assumed lateral and vertical flight path might contain lateral turns as well as altitude changes on descent. Available solutions further use the assumed lateral path and the assumed vertical path to calculate and display optimum energy and critical energy indicators. However, a technical problem is presented, in that neither the assumed lateral path nor the assumed vertical path is depicted graphically on the INAV and VSD. In these scenarios, the optimum energy and critical energy indicators are depicted generally in front of the aircraft symbol, but not visually associated with the assumed flight path because the assumed flight path isn't depicted on the avionic display. This technical problem is a deficiency in a human-machine interface (HMI), as it can make it very difficult for a pilot to see a big picture of the descent situation, especially when the assumed flight path contains horizontal turns or altitude changes.

Provided embodiments provide a technical solution in the form of a flight display system that provides a visualization on an avionic display of the assumed lateral and vertical flight paths. Additionally, embodiments provide an optimum energy indicator, and a critical energy indicator, and position them each at respective applicable locations on the assumed lateral path and assumed vertical path. With these features, the present disclosure provides an objectively improved HMI.

Embodiments of the present disclosure build upon an algorithm in the Approach Stabilization Assistant (AStA) disclosed in the aforementioned U.S. patent application publication no. 2017/0168658 A1. The AstA algorithm is used to help the pilot to manage the aircraft energy during descent and approach so the aircraft will be stabilized at the final gate (defined above). Provided embodiments are compatible with the AStA and its algorithm that provides a graphical user interface (GUI) and specific graphical clues depicted on avionic displays, and which improve a pilot's awareness and understanding of the current energy state of the aircraft in comparison to the optimum and critical energy state for the given approach.

The AstA algorithm receives and processes the type of aircraft, flight plan, the weight of the aircraft, current weather conditions (at the aircraft and at the airport), aircraft configuration options and aircraft configuration status, the position of the aircraft with regard to the airport, standard approach procedures, and current airspeed.

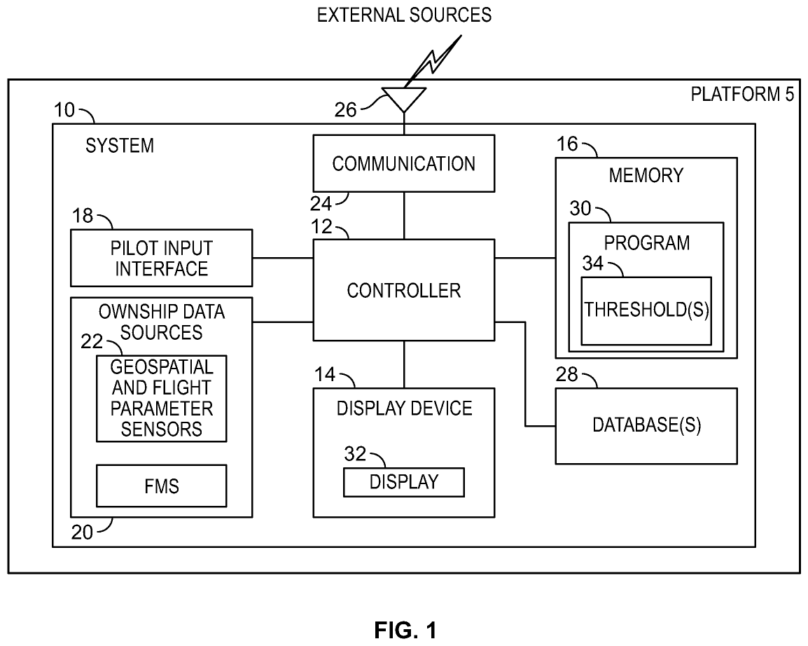

FIG. 1 is a block diagram of a system 10 for providing a visualization of an assumed lateral and vertical flight path on an avionic display for an aircraft performing energy management during an approach procedure (shortened herein to “system” 10), as illustrated in accordance with an exemplary and non-limiting embodiment of the present disclosure. The system 10 may be utilized onboard a mobile platform 5 to provide visual guidance, as described herein. In various embodiments, the mobile platform is an aircraft 5, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) and an array of flight system status and geospatial sensors 22.

In various embodiments, the system 10 may be separate from or integrated within: the flight management system (FMS) and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the Aircraft 5.

The term “controller circuit” (and its simplification, “controller”), broadly encompasses those components utilized to carry-out or otherwise support the processing functionalities of the system 10. Accordingly, controller circuit 12 can encompass or may be associated with a programmable logic array, application specific integrated circuit or other similar firmware, as well as any number of individual processors, flight control computers, navigational equipment pieces, computer-readable memories (including or in addition to memory 16), power supplies, storage devices, interface cards, and other standardized components. In various embodiments, controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, program 30, that embodies an algorithm described herein for receiving and processing data to thereby display a visualization of an assumed lateral and vertical flight path on an avionic display for an aircraft 5, and to accordingly perform the various process steps, tasks, calculations, and control/display functions described herein.

Controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

Memory 16 is a data storage that can encompass any number and type of storage media suitable for storing computer-readable code or instructions, such as the aforementioned software program 30, as well as other data generally supporting the operation of the system 10. Memory 16 may also store one or more threshold 34 values, for use by an algorithm embodied in software program 30. Examples of threshold 34 values include margins of error for altitude deviations, airspeed deviations, and lateral deviations. One or more database(s) 28 are another form of storage media; they may be integrated with memory 16 or separate from it.

In various embodiments, aircraft-specific parameters and information for aircraft 5 may be stored in the memory 16 or in a database 28 and referenced by the program 30. Non-limiting examples of aircraft-specific information includes an aircraft weight and dimensions, performance capabilities, configuration options, and the like.

In various embodiments, two- or three-dimensional map data may be stored in a database 28, including airport features data, geographical (terrain), buildings, bridges, and other structures, street maps, and navigational databases, which may be updated on a periodic or iterative basis to ensure data timeliness. This map data may be uploaded into the database 28 at an initialization step and then periodically updated, as directed by either a program 30 update or by an externally triggered update.

Flight parameter sensors and geospatial sensors 22 supply various types of data or measurements to controller circuit 12 during Aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, display device 14 can include any number and type of image generating devices on which one or more avionic displays 32 may be produced. When the system 10 is utilized for a manned Aircraft, display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the Aircraft cockpit by a pilot.

At least one avionic display 32 is generated on display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the Aircraft 5 at its current location within the map data. The avionic display 32 generated and controlled by the system 10 can include graphical user interface (GUI) objects and alphanumerical input displays of the type commonly presented on the screens of MCDUs, as well as Control Display Units (CDUs) generally. Specifically, embodiments of avionic displays 32 include one or more two dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance broadcast (ADSB), and enhanced vision systems (EVS).

In certain embodiments of system 10, the controller circuit 12 and the other components of the system 10 may be integrated within or cooperate with any number and type of systems commonly deployed onboard an aircraft including, for example, an FMS, and the aforementioned AstA.

The disclosed algorithm is embodied in a hardware program or software program (e.g. program 30 in controller circuit 12) and configured to operate when the aircraft 5 is several thousand feet above (destination) aerodrome level (AAL), for example at least about 5000 ft. AAL, such as at least about 10000 ft. AAL, or more preferably at least about 15,000 ft. AAL. The algorithm provides flight crew instructions via the avionic display 32 down to 500 ft. AAL. This number is configurable, and can be changed anytime. In various embodiments, the disclosed algorithm may employ a 300 ft. AAL for a circling approach. The algorithm in program 30 also determines the available distance to go between the aircraft current position and the runway. This information can be read from aircraft flight management system (FMS) or it can be calculated independently by the algorithm. In various embodiments, a combination of these two is employed to provide even better results.

In various embodiments, the provided controller circuit 12 is integrated with the aforementioned AstA, and therefore its program 30 may incorporate the programming instructions necessary for: (a) the AstA algorithm, with rules for calculating, receiving and processing aircraft status data and aircraft configuration data, determining a current energy situation of the aircraft, and commanding the display device to render the navigation display and the VSD on the display device (e.g., the controller circuit 12 may determine the current energy situation of the aircraft based on a distance from a current position of the aircraft to a final gate or based on an airspeed of the aircraft); and (b) the human-machine interface (HMI) of the AstA, which controls the graphical user interface (GUI) presented on the display device 14.

Because the present algorithm may incorporate the AstA algorithm, some aspects of the AstA are briefly referenced for convenience. First, the AstA algorithm is understood to calculate an optimum deceleration profile on given vertical or lateral path and provide, as part of a GUI on an avionic display, visual indicators to advise the flight crew regarding a configuration change (for example, extending flaps, speed brakes, and/or landing gear, etc.) to achieve the most energy efficient (e.g., with the lowest possible costs) and quiet approach while still assuring that the approach is stabilized and safe. The GUI is implemented as a graphical element on existing display system blocks, as a standalone display on an existing aircraft display, or as a standalone display running on an electronic flight-bag of the aircraft.

Next, the AstA algorithm is further understood to monitor aircraft parameters and offer non-standard corrective actions to allow the aircraft to reach a stabilized approach prior to the landing decision altitude (for example, 1000 feet AAL). For example, such non-standard corrective actions include, but are not limited to, the use of speed-brakes, an early landing gear extension, and/or level flight deceleration.

Additionally, the AstA algorithm further evaluates whether the aircraft is able to meet the stabilized approach criteria even with the use of non-standard corrective actions. In the event that even these actions are calculated to be insufficient to bring the aircraft to a stabilized approach prior to reaching the minimum decent altitude, the GUI provides an indication and advises the crew to commence a go around procedure.

And finally, the AstA algorithm, when executed by the controller circuit 12, generates and renders a graphical user interface (GUI) on the display device 14. The GUI comprises a plurality of GUI objects, including a current aircraft position symbol indicative of a current position of the aircraft 5.

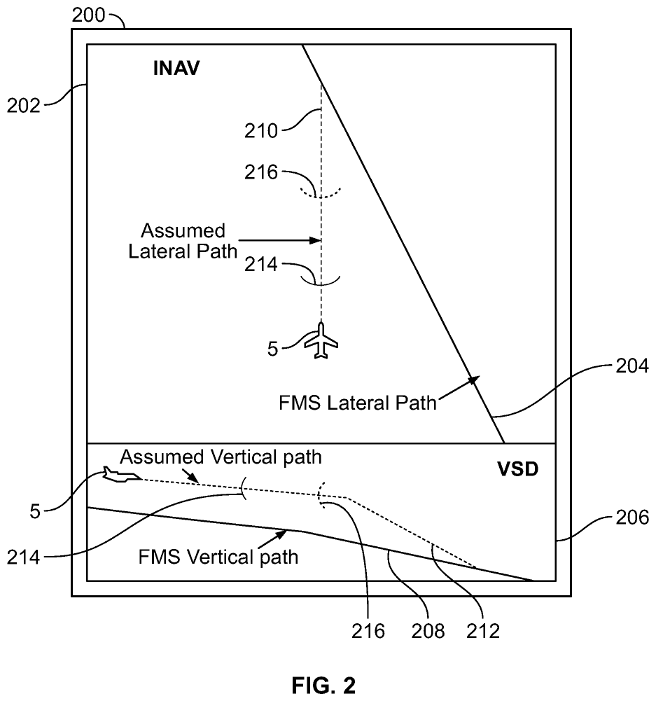

The present invention builds upon the AstA GUI as follows. Turning now to FIG. 2, a simplified illustration is used to introduce features of a visualization of an assumed lateral and vertical flight path on an avionic display for an aircraft performing energy management during an approach procedure. During operation, the controller circuit 12, which is programmed by programming instructions to receive and process aircraft status data and aircraft configuration data, determines a current energy situation of the aircraft, and commands the display device to render the navigation display and the VSD. Avionic display 200 includes a horizontal or navigation display (INAV) 202 and a vertical situation display (VSD) 206. The controller circuit 12 determined that the aircraft 5 is not on the FMS lateral path 204, nor is it on the FMS vertical path 208. Responsive thereto, the controller circuit 12 constructs an assumed lateral path and an assumed vertical path.

The controller circuit 12 generates a first graphical user interface (GUI) object representing the assumed lateral path 210 when the aircraft is not on the FMS lateral path. The controller circuit 12 generates a second graphical user interface (GUI) object representing the assumed vertical path 212 when the aircraft is not on the FMS vertical path. The first GUI object and the second GUI object are rendered on the existing avionic display 32 in the INAV 202 and in the VSD 206. As can be seen in FIG. 2, the concurrently visually displayed presentation (i.e., the visualization) of these assumed paths is an objective improvement in the HMI, as one can immediately see where the aircraft is with respect to assumed geometrical trajectory and its targets.

As mentioned, and based on the AstA algorithm included within program 30, the controller circuit 12 is programmed to determine an optimum energy position 214 on the descent, defined as a position, from which the aircraft will decelerate to the speed for optimum configuration change. The controller circuit 12 is also programmed to determine a critical energy position 216 on the descent, defined as a position, from which the aircraft will decelerate to the speed for critical configuration change, wherein the critical configuration represents a maximum drag configuration of the aircraft that is greater than the optimum configuration and involves the extension of each of: flaps, airbrakes, and landing gear, the critical energy position represents a position after which, regardless of aircraft configuration, the aircraft can no longer arrive at the final gate in the energy-stabilized manner.

The controller circuit 12 selects a presentation style from among a plurality of presentation styles for rendering indicators for these positions, i.e., an optimum energy indicator and a critical energy indicator. In various embodiments, the selected presentation style for the critical energy indicator and the optimum energy indicator includes rendering the indicators as one of an arc, a line, a chevron, and a diamond; however, other presentation styles may be utilized. In various embodiments, the critical energy indicator is rendered with a heavier line weight than the optimum energy indicator.

Going beyond the AstA algorithm, the program 30 comprises rules, which when executed by the controller circuit 12, cause the controller circuit to render the optimum energy indicator 214, as an overlay, on each of the first GUI object and the second GUI object; and, render the critical energy indicator 216, as an overlay, on each of the first GUI object and the second GUI object. The controller circuit 12 is further programmed to locate the optimum energy indicator 214 and the critical energy indicator 216 on the GUI object for the respective assumed paths in relative positions with respect to the current aircraft position symbol and respective assumed path, based on the current energy situation. The rendering is done in accordance with the selected presentation style. As can be seen in FIG. 2, the additional overlay of the indicators directly on the visualized assumed paths is another objective improvement in the HMI, as one can immediately see exactly where configuration changes are to be made.

In various embodiments, the controller circuit 12 determines when the aircraft 5 has descended to the final gate; and stops rendering the critical energy indicator and the optimum energy indicator when the aircraft has descended to 500 feet AAL at the final gate. In various embodiments, the controller circuit 12 determines when the aircraft 5 has ascended to 1000 feet above aerodrome level (AAL) at the final gate; and stops rendering the critical energy indicator and the optimum energy indicator when the aircraft has descended to 1000 feet AAL at the final gate.

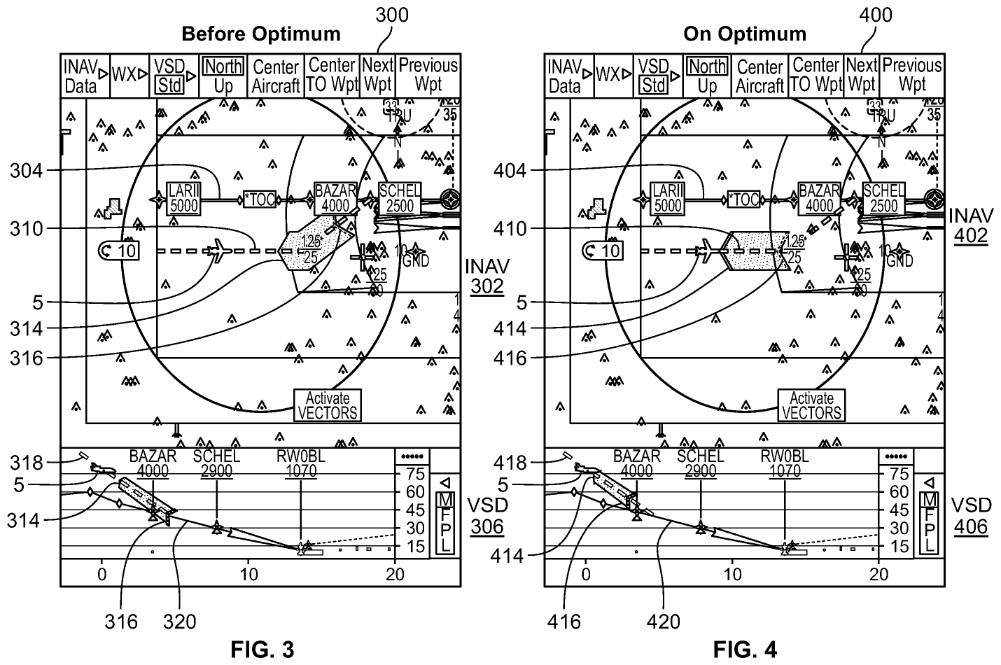

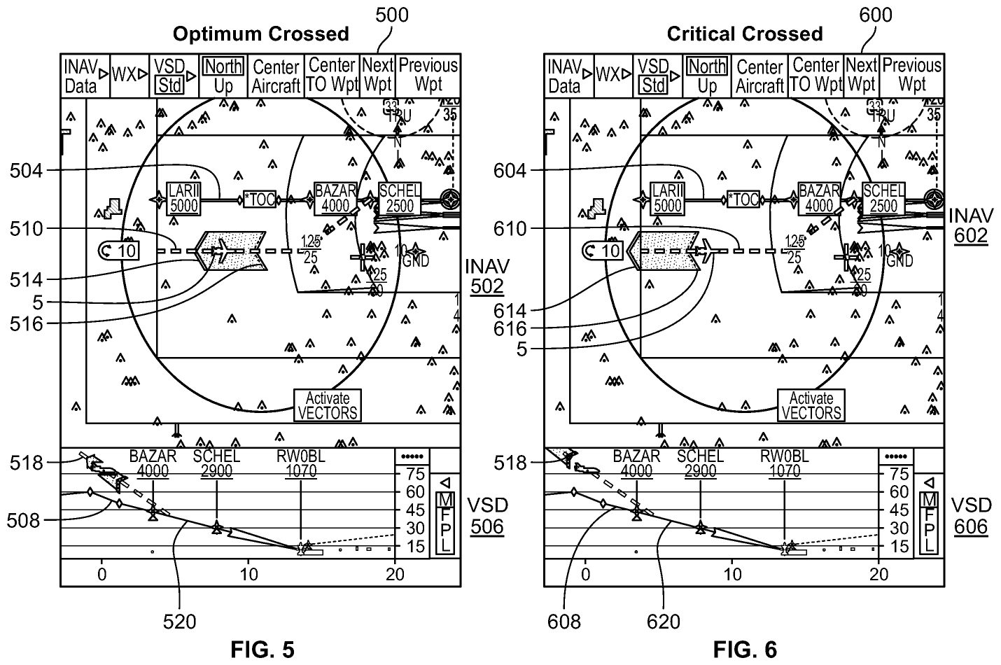

FIGS. 3-6 are more detailed illustrations showing varying aircraft 5 locations and the improved HMI provided by system 10. FIGS. 3-6 comprise additional GUI information such as terrain data. Avionic display 300 includes INAV 302 and VSD 306. The FMS lateral path 304 and the FMS vertical path 320 are shown. Aircraft 5 is shown on assumed lateral path 310 and assumed vertical path 318. The optimum energy indicator 314 is a chevron of a first line width and the critical energy indicator 316 is a chevron with a second line width that is thicker than the first line width. An area connecting the optimum energy indicator 314 and the critical energy indicator 316 is shown shaded, and further, one can see it lightly shaded where it is closest to the optimum energy indicator 314, and the shading becomes darker where it is closest to the critical energy indicator 316. The shading is one of many available presentation styles.

Avionic display 400 includes INAV 402 and VSD 406. The FMS lateral path 404 and the FMS vertical path 420 are shown. Aircraft 5 is shown on assumed lateral path 410 and assumed vertical path 418. The optimum energy indicator 414 is a chevron of a first line width and the critical energy indicator 416 is a chevron with a second line width that is thicker than the first line width. An area connecting the optimum energy indicator 414 and the critical energy indicator 416 is shown shaded, and further, one can see it lightly shaded where it is closest to the optimum energy indicator 414, and the shading becomes darker where it is closest to the critical energy indicator 416.

Avionic display 500 includes INAV 502 and VSD 506. The FMS lateral path 504 and the FMS vertical path 520 are shown. Aircraft 5 is shown on assumed lateral path 510 and assumed vertical path 518. The optimum energy indicator 514 is a chevron of a first line width and the critical energy indicator 516 is a chevron with a second line width that is thicker than the first line width. An area connecting the optimum energy indicator 514 and the critical energy indicator 516 is shown shaded, and further, one can see it lightly shaded where it is closest to the optimum energy indicator 514, and the shading becomes darker where it is closest to the critical energy indicator 516.

Avionic display 600 includes INAV 602 and VSD 606. The FMS lateral path 604 and the FMS vertical path 620 are shown. Aircraft 5 is shown on assumed lateral path 610 and assumed vertical path 618. The optimum energy indicator 614 is a chevron of a first line width and the critical energy indicator 616 is a chevron with a second line width that is thicker than the first line width. An area connecting the optimum energy indicator 614 and the critical energy indicator 616 is shown shaded, and further, one can see it lightly shaded where it is closest to the optimum energy indicator 614, and the shading becomes darker where it is closest to the critical energy indicator 616.

Viewing FIGS. 3-6 as a sequence, one can see the avionic display 32 for the aircraft 5 flying prior to the optimum energy indicator 314, then approaching the optimum energy indicator 414, then in between the optimum energy indicator 514 and the critical energy indicator 516, and then, in FIG. 6, the aircraft 5 has flown past the critical energy indicator 516. As alluded to, the guidance provided to the pilot at the optimum energy indicator 514 and the guidance provided to the pilot at the critical energy indicator 516 are vital to an aircraft performing energy management during an approach procedure. Viewing FIGS. 3-6 as a sequence allow one to observe the improved HMI provided to a pilot by the present invention during this critical procedure.

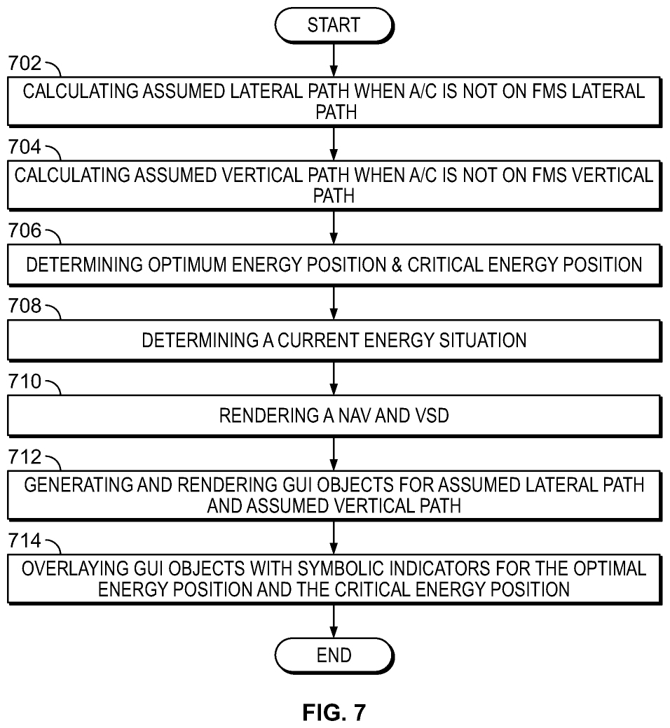

In an embodiment, as shown in FIG. 7, a flow diagram is provided illustrating a method 700 for generating a flight display in accordance with the present disclosure. At 702, the method calculates an assumed lateral path when the aircraft is not on FMS lateral path. At 704 the method calculates an assumed vertical path when the aircraft is not on FMS vertical path.

At 706 an aircraft an optimum energy position and an aircraft critical energy position are determined using the algorithm. At 708, an aircraft current energy situation is determined using the algorithm.

At 710, avionic displays of the type NAV and VSD are rendered on a display device 14. At 712, generating and rendering GUI objects for assumed lateral path and assumed vertical path are performed.

At 714, the method performs the process of overlaying GUI objects with symbolic indicators for the optimal energy position and the critical energy position.

As stated above, in various embodiments, some of the tasks performed in 702 to 710 are handled by an AstA algorithm, and the remaining steps operate on output from the AstA algorithm.

At 712, the algorithm utilizes the calculated paths from step 702 and step 704 to generate and render a GUI object for the assumed lateral path and generate and render a GUI object for the assumed vertical path. At 714, the algorithm renders the GUI objects on an existing GUI on the NAV and the VSD.

At 716, the algorithm overlays the GUI objects generated in 714 with symbolic indicators to show the location of the optimum energy position and the location of the critical energy position. In various embodiments, the algorithm monitors altitude and stops the rendering of the indicators based on a current altitude of the aircraft.

As such, disclosed herein is flight display system for providing a visualization of an assumed lateral and vertical flight path on an avionic display for an aircraft performing energy management during an approach procedure. The system 10 improves upon available algorithms by providing a visualization of an assumed lateral and vertical flight path to assist the flight crew in making adjustments to the configuration of the aircraft when the aircraft is making an approach to an airport. Thus, the system 102 provides an objectively improved human-machine interface (HMI).

While the present disclosure has provided exemplary embodiments directed to a flight display system, it will be appreciated that the embodiments presented herein can be extended to other applications where approach assistance may be desirable, and where approaches may be improved through the use of a display. For example, other suitable applications may include maritime applications, railroad applications, industrial/manufacturing plant applications, space travel applications, simulator applications, and others as will be appreciated by those having ordinary skill in the art.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It is being understood that various changes may be made in the function and arrangement of elements described in an exemplary embodiment without departing from the scope of the invention as set forth in the appended claims.

What is claimed is:

1. A flight display system for providing a visualization of an assumed lateral and vertical flight path on an avionic display for an aircraft performing energy management during an approach procedure, comprising:
a flight management system (FMS);
a source of aircraft status data;
a display device capable of rendering a navigation display and a vertical situation display (VSD); and
a controller circuit coupled to the FMS, the source of aircraft status data, and the display device, the controller circuit programmed by programming instructions to receive and process aircraft status data and aircraft configuration data, determine a current energy situation of the aircraft, and to command the display device to render the navigation display and the VSD, the controller circuit further programmed to:
determine an optimum energy position on the descent, defined as a position for employing an optimum configuration for energy on the descent, as a function of the current energy situation;
determine a critical energy position on the descent, defined as a position for changing an aircraft configuration to a final configuration, wherein the final configuration represents a maximum drag configuration of the aircraft that is greater than the optimum configuration and involves the extension of each of: flaps, airbrakes, and landing gear, the critical energy position represents a position after which, regardless of aircraft configuration, the aircraft can no longer arrive at the final approach gate in the energy-stabilized manner;
determine when the aircraft is not on an FMS lateral path;
calculate an assumed lateral path when the aircraft is not on the FMS lateral path;
generate a first graphical user interface (GUI) object representing the assumed lateral path when the aircraft is not on the FMS lateral path;
render the first GUI object on the navigation display;
determine when the aircraft is not on an FMS vertical path;
calculate an assumed vertical path when the aircraft is not on the FMS vertical path;
generate a second graphical user interface (GUI) object representing the assumed vertical path when the aircraft is not on the FMS vertical path;
render the second GUI on the VSD;
select a presentation style from among a plurality of presentation styles for rendering an optimum energy indicator and a critical energy indicator;
render the optimum energy indicator, as an overlay, on each of the first GUI object and the second GUI object; and
render the critical energy indicator, as an overlay, on each of the first GUI object and the second GUI object.

2. The flight display system of claim 1, wherein the controller circuit determines the current energy situation of the aircraft based on a distance from a current position of the aircraft to a final gate or based on an airspeed of the aircraft.

3. The flight display system of claim 1, wherein the first GUI object and the second GUI object are two of a plurality of GUI objects making up a graphical user interface (GUI) rendered on the display device by the controller circuit, the GUI further comprises a current aircraft position symbol indicative of a current position of the aircraft, and wherein:
the controller circuit is further programmed to locate the optimum energy indicator and the critical energy indicator on the GUI in relative positions with respect to the current aircraft position symbol and respective assumed path, based on the current energy situation.

4. The flight display system of claim 3, wherein the GUI is implemented as a graphical element on existing display system blocks, as a standalone display on an existing aircraft display, or as a standalone display running on an electronic flight-bag of the aircraft.

5. The flight display system of claim 1, wherein the selected presentation style for the critical energy indicator and the optimum energy indicator includes rendering the indicators as one of an arc, a line, a chevron, and a diamond.

6. The flight display system of claim 5, wherein the critical energy indicator is rendered with a heavier line weight than the optimum energy indicator.

7. The flight display system of claim 5, wherein the controller circuit is further configured to:
determine when the aircraft has descended to the final gate; and
stop rendering the critical energy indicator and the optimum energy indicator when the aircraft has descended to the final gate.

8. The flight display system of claim 5, wherein the controller circuit is further configured to:
determine when the aircraft has ascended to 1000 feet above aerodrome level (AAL) at the final gate; and
stop rendering the critical energy indicator and the optimum energy indicator when the aircraft has descended to 1000 feet AAL at the final gate.

9. A method for providing a visualization of an assumed lateral and vertical flight path on an avionic display for an aircraft performing energy management during an approach procedure, comprising:
at a controller circuit programmed by programming instructions,
receiving and processing aircraft status data and aircraft configuration data, determining a current energy situation of the aircraft, and commanding a display device to render a navigation display and a VSD;
determining an optimum energy position on the descent, defined as a position, from which the aircraft will decelerate to a speed for an optimum configuration change;
determining a critical energy position on the descent, defined as a position, from which the aircraft will decelerate to a speed for a change to a critical configuration, wherein the critical configuration represents a maximum drag configuration of the aircraft that is greater than the optimum configuration and involves the extension of each of: flaps, airbrakes, and landing gear, the critical energy position represents a position after which, regardless of aircraft configuration, the aircraft can no longer arrive at the final approach gate in the energy-stabilized manner;
determining when the aircraft is not on an FMS lateral path;
calculating an assumed lateral path when the aircraft is not on the FMS lateral path;
generating a first graphical user interface (GUI) object representing the assumed lateral path when the aircraft is not on the FMS lateral path;
rendering the first GUI object on the navigation display;
determining when the aircraft is not on an FMS vertical path;
calculating an assumed vertical path when the aircraft is not on the FMS vertical path;
generating a second graphical user interface (GUI) object representing the assumed vertical path when the aircraft is not on the FMS vertical path;
rendering the second GUI on the VSD;
selecting a presentation style from among a plurality of presentation styles for rendering an optimum energy indicator and a critical energy indicator;
rendering the optimum energy indicator, as an overlay, on each of the first GUI object and the second GUI object; and
rendering the critical energy indicator, as an overlay, on each of the first GUI object and the second GUI object.

10. The method of claim 9, wherein the first GUI object and the second GUI object are two of a plurality of GUI objects making up a graphical user interface (GUI) rendered on the display device by the controller circuit, the GUI further comprises a current aircraft position symbol indicative of a current position of the aircraft, and further comprising locating the optimum energy indicator and the critical energy indicator on the GUI in relative positions with respect to the current aircraft position symbol and respective assumed path, based on the current energy situation.

11. The method of claim 10, wherein the selected presentation style for the critical energy indicator and the optimum energy indicator includes rendering the indicators as one of an arc, a line, a chevron, and a diamond.

12. The method of claim 13, wherein the critical energy indicator is rendered with a heavier line weight than the optimum energy indicator.

13. The method of claim 11, further comprising implementing the GUI as a graphical element on existing display system blocks, as a standalone display on an existing aircraft display, or as a standalone display running on an electronic flight-bag of the aircraft.

14. The method of claim 12, further comprising determining the current energy situation of the aircraft based on a distance from a current position of the aircraft to a final gate or based on an airspeed of the aircraft.

15. The method of claim 14, further comprising:
determining when the aircraft has descended to the final gate; and
stopping rendering the critical energy indicator and the optimum energy indicator when the aircraft has descended to the final gate.

16. The method of claim 15, further comprising:
determining when the aircraft has ascended to 1000 feet above the final gate; and
stopping rendering the critical energy indicator and the optimum energy indicator when the aircraft has descended to the final gate.

17. A flight display system for providing a visualization of an assumed lateral and vertical flight path on an avionic display for an aircraft performing energy management during an approach procedure, the flight display system comprising a computer processor programed to determine a current energy situation of the aircraft, determine an optimum energy position, defined as a position for employing an optimum configuration for energy on a descent, determine a critical energy position on the descent, defined as a position for changing an aircraft configuration to a final configuration that represents a maximum drag configuration of the aircraft that is greater than the optimum configuration and involves the extension of each of: flaps, airbrakes, and landing gear, calculate an assumed lateral path when the aircraft is not on the FMS lateral path, and calculate an assumed vertical path when the aircraft is not on the FMS vertical path, the flight display system comprising:
a display device capable of rendering a navigation display and a vertical situation display (VSD); and
a controller circuit coupled to the display device, the controller circuit programmed by programming instructions to
command the display device to render the navigation display and the VSD;
generate a first graphical user interface (GUI) object representing the assumed lateral path when the aircraft is not on the FMS lateral path;
render the first GUI object on the navigation display;
generate a second graphical user interface (GUI) object representing the assumed vertical path when the aircraft is not on the FMS vertical path;
render the second GUI on the VSD;
select a presentation style from among a plurality of presentation styles for rendering an optimum energy indicator and a critical energy indicator;
render the optimum energy indicator, as an overlay, on each of the first GUI object and the second GUI object; and
render the critical energy indicator, as an overlay, on each of the first GUI object and the second GUI object.

18. The flight display system of claim 17, wherein the controller circuit is further programmed to locate the optimum energy indicator and the critical energy indicator on the GUI in relative positions with respect to the current aircraft position symbol and respective assumed path, based on the current energy situation

19. The flight display system of claim 18, wherein the selected presentation style for the critical energy indicator and the optimum energy indicator includes rendering the indicators as one of an arc, a line, a chevron, and a diamond.

20. The flight display system of claim 18, wherein the critical energy indicator is rendered with a heavier line weight than the optimum energy indicator.
